(19) United States
(12) Patent Application Publication
(10) Pub. No.: US 2002/0190171 A1
(43) Pub. Date: Dec. 19, 2002

(54) Console bracket for supporting electronic apparatus

(76) Inventor: Michael H. Stock, Elkhart, IN (US)

Correspondence Address: James D. Hall, Botkin & Leone, Suite 400, 105 E. Jefferson Boulevard, South Bend, IN, 46601, US

(21) Appl. No.: 09/884,869

(22) Filed: Jun. 19, 2001

(51) Int. Cl. A47K 1/00; F16L 3/08

(52) U.S. Cl. 248/224.7; 248/224.51

(57) ABSTRACT

A bracket which is used for supporting electronic apparatus and which is adapted for removable connection to the console normally found in vehicles. The bracket includes a tongue part which is connectable to the console and a connector which is spaced from the tongue part and which is adapted for connection to the apparatus.

### SUMMARY OF THE INVENTION

This invention relates to a bracket and will have specific application to a bracket used to connect electronic apparatus to a console normally found in vehicles.

It is common practice to mount electronic apparatus such as television sets, DVD players, and CD players within motorized vehicles such as motor homes, automobiles and sport utility vehicles. Normally, such apparatus is permanently mounted within the vehicle so as to prevent its unauthorized taking. In this invention a bracket has been designed which is mountable to a component of the vehicle such as a console and which allows the electronic apparatus to be disconnected and removed from the vehicle for either safety reasons or in home use.

The bracket of this invention includes a tongue part which is releasably connectable to the console and a tongue part which extends laterally from the console and is adapted for connection to the electronic apparatus. The connector is preferably of two part form which allows one part of the connector to be secured to the apparatus and snap fitted or interconnected with the other part to secure the apparatus to the bracket. When desired, the connecter can be released so to permit the apparatus to be separated from the remainder of the bracket.

Accordingly, is it the object of this invention to provide a bracket for supporting electronic apparatus and which is mountable within the interior of a vehicle.

The other object of this invention is provide a bracket for releasably mounting electronic apparatus within the interior of a vehicle.

Still another object of this invention to provide a bracket of economical construction and of simple and reliable operation for releasably mounting electronic apparatus within the interior of a vehicle.

Other objects of this invention will become apparent upon the reading of the following description.

### BRIEF DESCRIPTION OF THE DRAWINGS

FIG. 1 is a perspective view of the console showing an electronic device mounted to the console by the bracket of this invention.

FIG. 2 is a perspective view of the bracket of this invention with the electronic device of FIG. 1 mounted to it and having its lid in closed form.

FIG. 3 is a fragmentary perspective view of the console showing the bracket of this invention releasably connected to the console and the electronic apparatus in disconnected form from the bracket.

FIG. 4 is a perspective view showing the component parts of the bracket of this invention in separated or exploded form.

FIG. 5 is a perspective view of the bracket shown in its assembled form.

FIG. 6 is a side view of the bracket of this invention shown supporting the electronic apparatus illustrated in broken line form.

FIG. 7 is a top view of the bracket of this invention as seen in FIG. 5.

FIG. 8 is a fragmentary detailed sectional view taken along line 8-8 of FIG. 7.

FIG. 9 is a fragmentary side view of a modified embodiment of the bracket of this invention shown supporting an electronic apparatus illustrated in broken line form.

FIG. 10 is a top view of the console with the bracket of FIG. 9 removably connected thereto.

### DESCRIPTION OF THE PREFERRED EMBODIMENTS

Preferred embodiments illustrated are not intended to be exhausted or to limit the inventions to the precise forms disclosed. They are described in order to enable one having an ordinary skill in the art to utilize the invention.

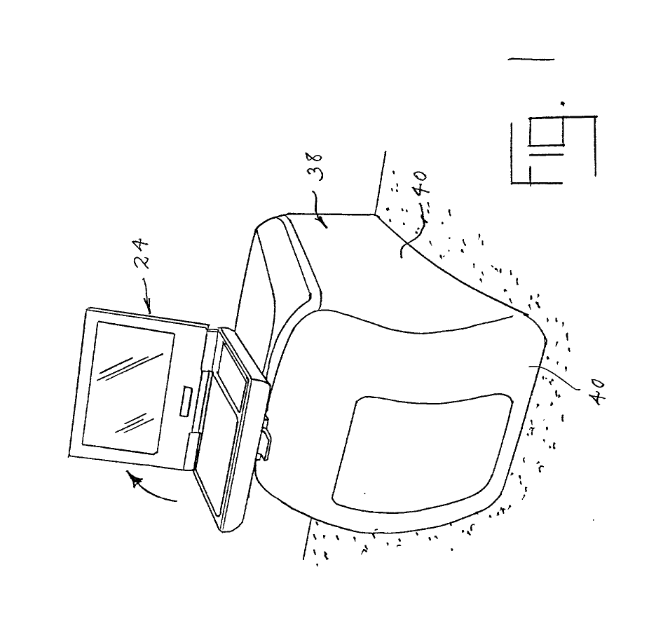

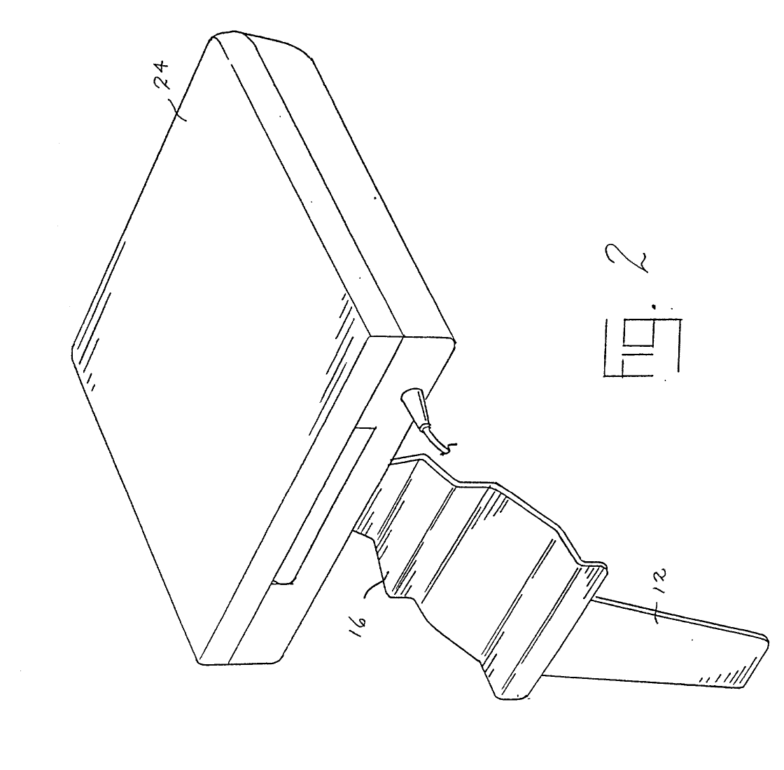

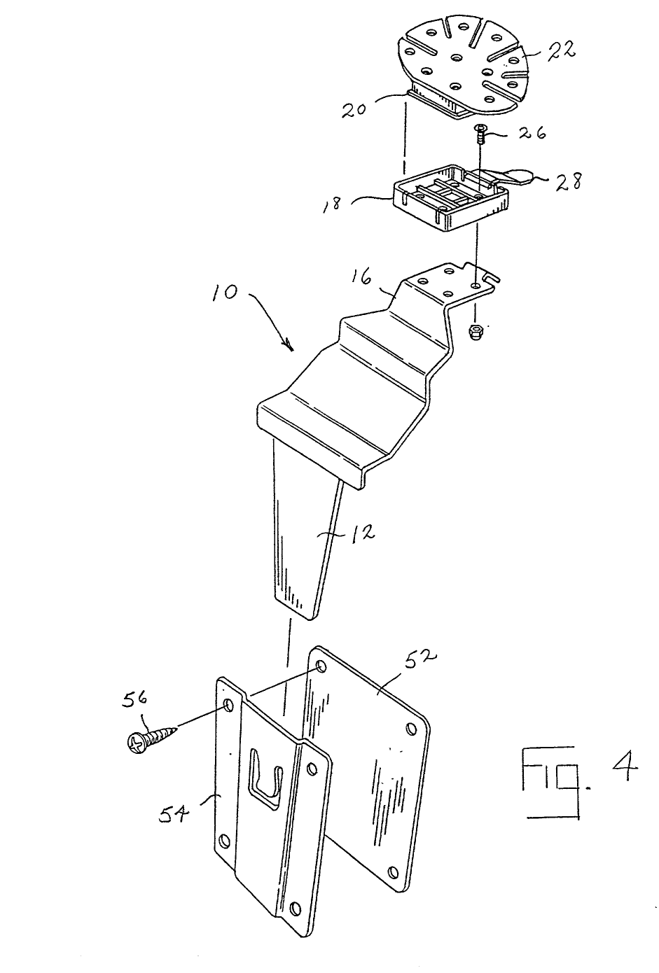

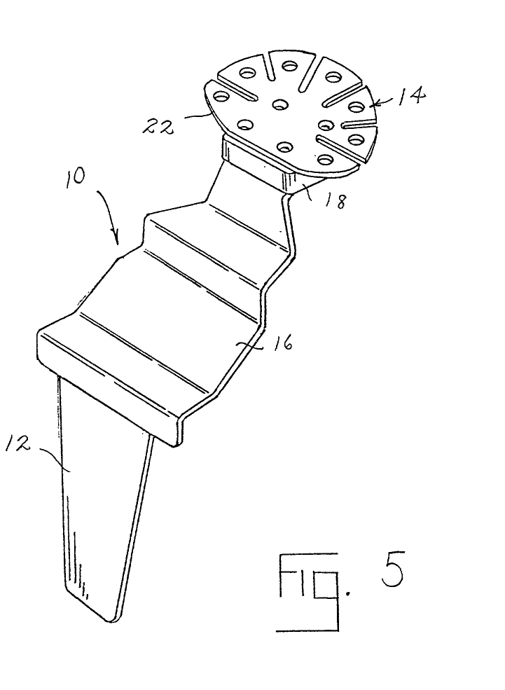

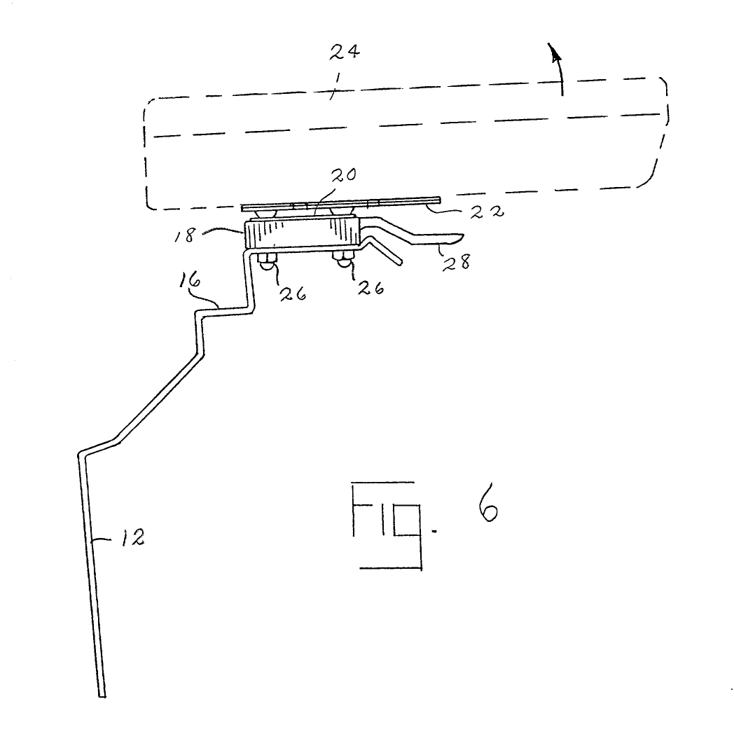

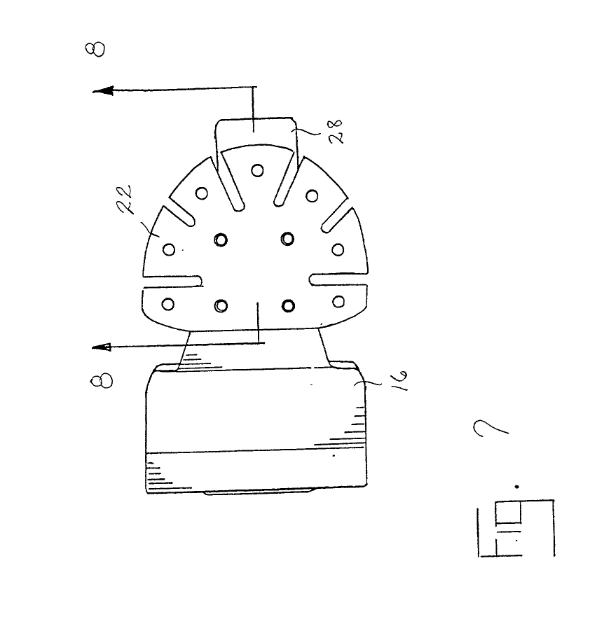

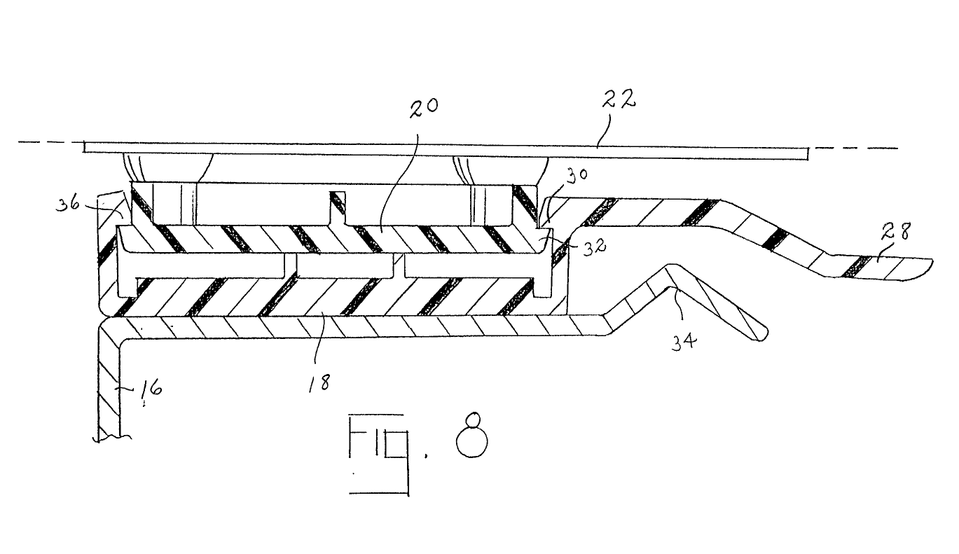

Referring first to FIGS. 4 and 5, bracket 10 includes a tongue part 12, a connector 14, which is interconnected to tongue 12 by an extension part 16. Connector 14 is of two part form, namely, a latch part 18 and a catch part 20. Catch part 20 includes a mounting plate 22 to which the electronic apparatus such as the DVD player 24, as shown in FIGS. 1-3, is connected. Latch part 18 is connected to extension part 16 of the bracket by suitable fasteners 26. As best seen in FIG. 8, latch part 18 which is formed of a flexible shape- retaining plastic includes a release tab 28. When release tab 28 is depressed, lip 30 of the tab is flexed outwardly and out of contact with circumferential rib 32 which is formed about the base of catch part 20, freeing the catch part from the latch part to allow the removal of the connected apparatus from the bracket. Extension part 16 includes an up-turned bend 34 which serves as a stop at maximum depression of release tab 28. To connect catch part 20 to latch part 18, the catch part is depressed into the latch part with rib 32 being cammed over lip 30 and an opposing lip 36 of the latch part causing the lips 30 and 36 to be flexed outwardly to allow the catch part to be snapfitted and retained within the latch part as shown in FIG. 8.

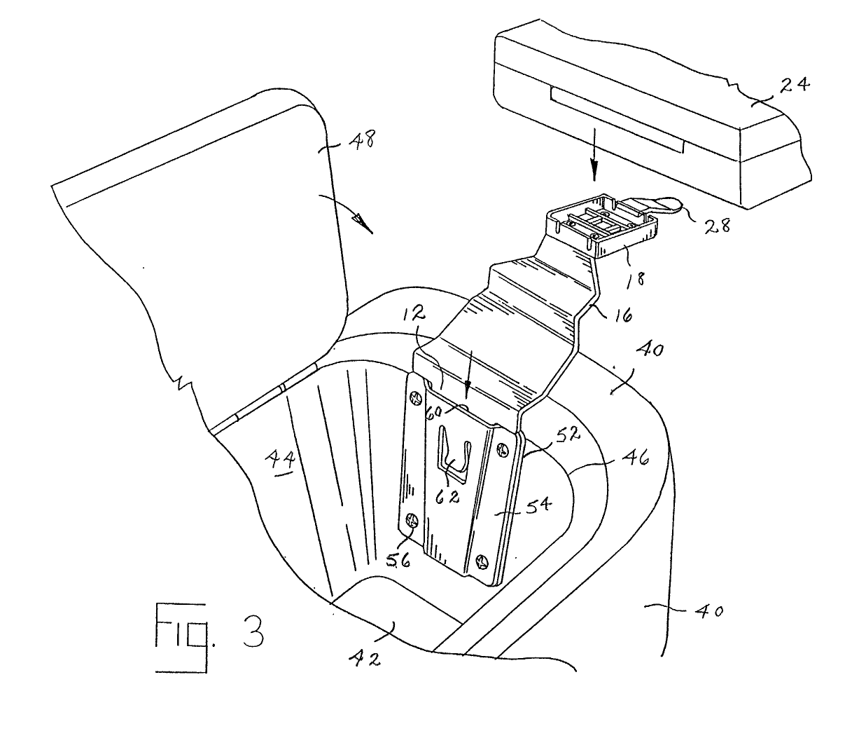

In FIG. 1, a console 38 is shown. Console 38 is of standard construction utilized in many vehicles and includes sidewalls 40 and a bottom wall 42, forming an interior recess 44 which is used for storage. Console 38 has a open top 46 into recess 44. A lid 48 spans the top 46 of console 38 in hinged fashion so as to swing between the open position shown in FIG. 3 and a closed position shown in FIG. 1. Console 38 may be mounted in an area between the spaced two front seats of the vehicle which is a common location. To mount bracket 10 to console 38, a receiver 50 is provided. Receiver 50 includes a bottom plate 52 and a top plate 54 which overlay one another and are connected by fasteners 56 within console recess 44 to one of the sidewalls 40 of the console as shown in FIG. 3. Top plate 54 is outwardly offset so as to form a channel 60 when the two plates are mounted together and attached to the console. Tongue part 12 of bracket 10 is fitted slidably into channel 60 to releasably secure the bracket to the console. A tab 62 formed in top plate 54 protrudes flexibly into channel 60 and serves as a frictional retainer for the tongue part when it is seated within the channel.

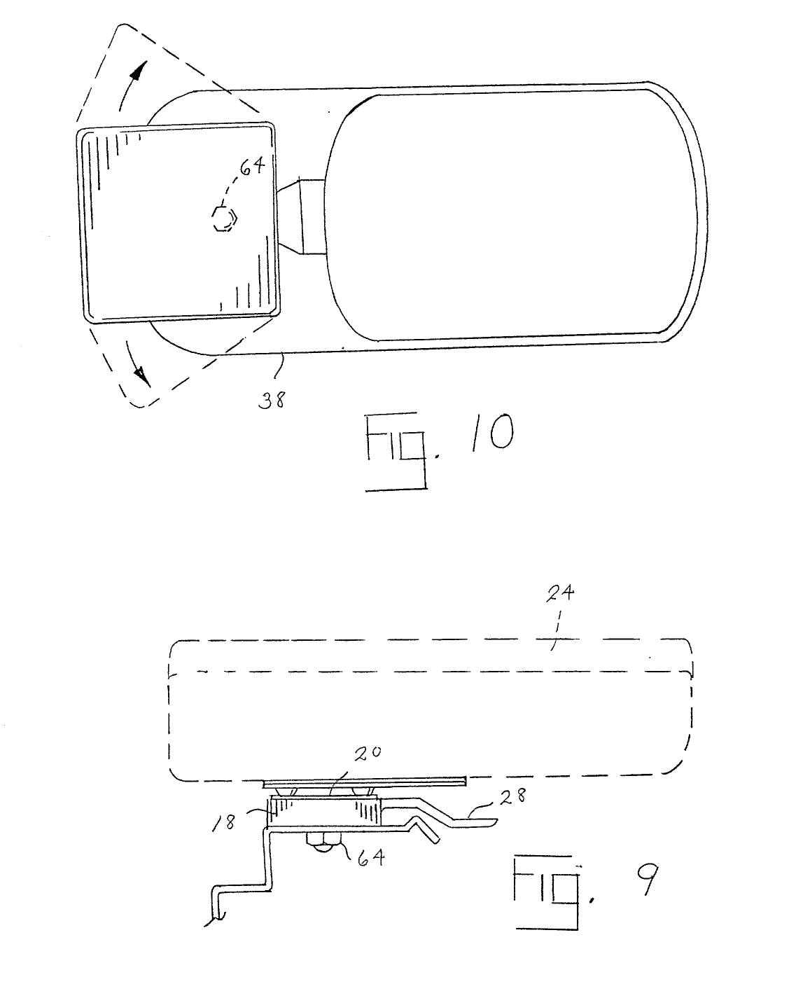

In FIGS. 9 and 10 the bracket 10 has been modified by having latch part 18 of connector 14 connected to extension part 16 by a pivot bolt 64. This form of connection between the latch part and the extension part allows connector 14 to be pivoted such as shown in the broken line positions in FIG. 10 so as to permit the repositioning or swiveling of the connected electronic apparatus when the bracket is mounted to the console.

The above described bracket 10 may be connected or disconnected from console 38 at the option of the user. Its connector 14 allows the supported electronic apparatus to be removed from the bracket with the bracket remaining attached to the console. Lid 48 of the console may be closed when bracket 10 is connected and is free to be opened to allow access to the interior recess 44 of the console at any time.

Bracket 10 and receiver 50 is preferably formed of metal while connecter 18 is preferably of plastic construction.

The invention as described is not to be limited to the details given but may be modified within the scope of the following claims.

What I claim is:

1. A bracket for supporting electronic apparatus for removable connection to a console or similar device, said bracket comprising a tongue part and a connector laterally separated from said tongue part, said tongue part being releasably connectable to said console, said connector adapted for connection to said apparatus.

2. The bracket of claim 1 and a receiver part adapted for securement to said console, said tongue part fitting releasably into said receiver part.

3. The bracket of claim 2 wherein said connector includes a first part and a second part releasably connected to said first part, said first part and tongue part being interconnected by an extension part, said second part being adapted for securement to said apparatus.

4. The bracket of claim 3 wherein said first part is pivotally connected to said extension part.

5. A console comprising a housing defined by sidewalls and a bottom wall to form a recess therein having an open top, a lid spanning said open top, said lid being shiftable between an open position spaced from the top and a closed position overlying the top, a receiver secured to one of said housing sidewalls, a bracket for supporting electronic apparatus, said bracket including a tongue part and a connector connected by an extension part, said tongue part removably fitted into said receiver with said connector projecting laterally from said housing with said lid in its closed position, said connector adapted for connection to said apparatus.

6. The console of claim 5 of said receivers secured to one said sidewall within said housing recess.

7. The console of claim 5 wherein said connector includes a first part and a second part releasably connected to said first part, said first part and tongue part being connected by an extension part, said second part being adapted for securement to said apparatus.

8. The console of claim 7 wherein said receiver is secured to said one sidewall within said housing recess.
